(19) United States
(12) Patent Application Publication
(10) Pub. No.: US 2026/0317200 A1
(43) Pub. Date: Oct. 15, 2026

(54) SYSTEM AND METHOD FOR OIL AND WATER SEPARATION

(71) Applicants: Jianbing Li, Prince George (CA); Jianliang Mao, Prince George (CA); Wei Deng, Prince George (CA)

(72) Inventors: Jianbing Li, Prince George (CA); Jianliang Mao, Prince George (CA); Wei Deng, Prince George (CA)

(21) Appl. No.: 19/440,094

(22) Filed: Jan. 5, 2026

Related U.S. Application Data
(60) Provisional application No. 63/741,546, filed on Jan. 3, 2025.

(51) Int. Cl. C02F 1/24; B01D 17/02; B01D 17/12; C02F 1/28; C02F 1/38; C02F 101/32; C02F 103/00

(52) U.S. Cl. CPC C02F 1/24; B01D 17/0205; B01D 17/0217; B01D 17/12; C02F 1/28; C02F 1/385; C02F 2101/32; C02F 2103/007; C02F 2201/008; C02F 2209/40; C02F 2303/16

(57) ABSTRACT

A system and method for separating oil and water is disclosed using a flotation tank having an contaminated water inlet, an oil outlet, and a water outlet and a bubble generator operably connected to the bubble inlet and operable to supply a quantity of bubbles into the interior of the flotation tank, wherein the oil outlet removes a quantity of oil collected by the bubbles from the interior of the flotation tank and the water outlet removes a quantity of the water having the oil removed therefrom from the interior of the flotation tank. The system further comprises an adsorption tank containing a quantity of an oil-absorbing material selectably connected to water outlet and a sensor operable cause water exiting the flotation tank through the water outlet to be directed to the adsorption tank when the concentration of oil in the water exiting the flotation tank exceeds a predetermined value.

### CROSS-REFERENCE TO RELATED APPLICATION

This application claims benefit of U.S. Provisional Patent Application No. 63/741,546 filed on Jan. 3, 2025 entitled System and Method for Oil and Water Separation.

### BACKGROUND

### 1. Technical Field

This disclosure relates generally to wastewater treatment and in particular to a method and system for removing oil from water.

### 2. Description of Related Art

Mechanical containment and recovery (MCR) using booms and skimmers is the primary method for collecting spilled oil from aquatic environments in Canada and the world. This method collects a large volume of oily wastewater that is usually emulsified, which takes up a large volume of storage space on response vessels for the skimmed water/oil mixture. Disadvantageously, the response vessels collecting the oily wastewater for safe disposal may run out of space in their holding tanks and must then remove themselves from the oil spill site to offload the liquid to the shore. This will significantly increase the spill response time and costs as well as potentially miss spill response operation window due to rapid change of sea conditions (e.g., waves, winds) after offloading the wastewater at the shore.

Another challenge of oil spill response is that the collected oily wastewater using MCR is usually emulsified which is difficult to separate. Conventional methods (such as gravity separation) are commonly used for decanting in current oil spill response operations. However, such methods are associated with low oil/water separation efficiency and long treatment time and may not be able to meet the environmental discharge standard.

### SUMMARY OF THE DISCLOSURE

According to a first embodiment of the present disclosure is a system for separating oil and water comprising a flotation tank having an contaminated water inlet, an oil outlet, and a water outlet and a bubble generator operably connected to the bubble inlet and operable to supply a quantity of bubbles into the interior of the flotation tank, wherein the oil outlet removes a quantity of oil collected by the bubbles from the interior of the flotation tank and the water outlet removes a quantity of the water having the oil removed therefrom from the interior of the flotation tank. The system further comprises an adsorption tank containing a quantity of an oil-absorbing material selectably connected to water outlet and a sensor operable cause water exiting the flotation tank through the water outlet to be directed to the adsorption tank when the concentration of oil in the water exiting the flotation tank exceeds a predetermined value.

The contaminated water inlet may be oriented at an angle relative to radial along the horizontal plane so as to induce a centripetal swirl motion in the flotation tank. The contaminated water inlet may comprise a plurality of inlets. The plurality of inlets may be arranged in a vertically spaced apart relation to each other. The plurality of inlets may be arranged radially around the flotation tank. The plurality of inlets may be selectable to adjust height in the flotation tank at which the contaminated water is introduced.

The system may further comprise an inlet pump to introduce the contaminated water into the flotation tank. The system may further comprise a holding tank operable to hold a quantity of the contaminated water wherein the inlet pump draws contaminated water from a bottom portion of the holding tank.

The system may further comprise a plurality of middle columns. The middle columns may be sealably connected to each other and the top and bottom caps with fasteners.

The system may further comprise a processor configured to receive data from the sensor and direct the water exiting the flotation tank to the adsorption tank if the oil concentration is above a predetermined level or to a discharge if the oil concentration is below the predetermined level.

The flotation tank may include bubble distribution ports therein. The bubble generator may be configured to recirculate a bubble-air mixture through the tank. The system may further comprise a backwash system operable to periodically clean the filler materials in the adsorption tank.

The flotation tank may include at least one sampling port for drawing off a quantity of the contents of the flotation tank. The at least one sampling port may comprise a plurality of sampling ports. The plurality of sampling ports may be arranged at varying heights along the flotation tank.

According to a further embodiment of the present disclosure is an apparatus for separating oil and water comprising a bottom cap having a separated water output therethrough and a bubble injection port extending thereinto, a top cap having a gas removal port therethrough and a separated oil port therethrough and at least one cylindrical middle column sealably locatable between the top and bottom caps, the middle column including at least one mixture inlet port operable to introduce a quantity of an oil-water mixture into the tank. The apparatus may further comprise a plurality of middle columns.

According to a further embodiment of the present disclosure is a method for separating oil and water comprising introducing a quantity of an oil contaminated water to a flotation tank, introducing a quantity of bubbles to the flotation tank at a bottom thereof, drawing a separated oil portion at a top of the flotation tank, drawing a separated water portion at a bottom of the flotation tank, measuring the oil concentration in the separated water portion and passing the separated water portion through an adsorption tank containing a quantity of an oil-absorbing material if the oil concentration in the separated water portion is above a predetermined value.

Other aspects and features of the present disclosure will become apparent to those ordinarily skilled in the art upon review of the following description of specific embodiments in conjunction with the accompanying figures.

### BRIEF DESCRIPTION OF THE DRAWINGS

The accompanying drawings constitute part of the disclosure. Each drawing illustrates exemplary aspects wherein similar characters of reference denote corresponding parts in each view,

FIG. 1 is an illustration of an oil spill clean up system according to a first embodiment of the present disclosure.

FIG. 2 is a schematic view of the system of FIG. 1.

FIG. 3 is a perspective illustration of a flotation tank for use in the system of FIG. 1.

FIG. 4 is a perspective view of a transportable container of the system of FIG. 1.

FIG. 5 is a cross sectional view of the flotation tank of FIG. 3 as taken along a horizontal plane.

### DETAILED DESCRIPTION

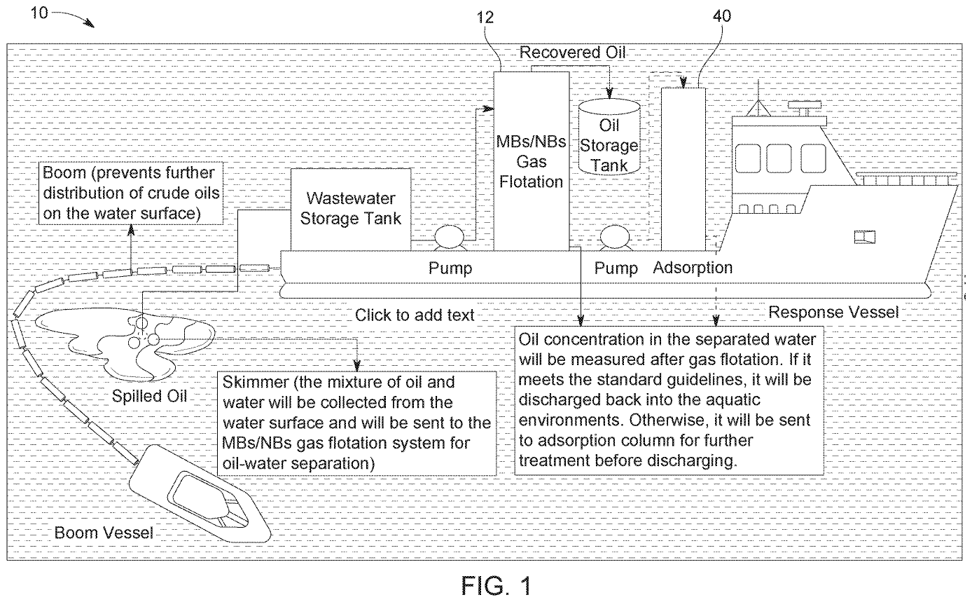

Referring to FIG. 1, an exemplary system for cleaning an oil spill is illustrated generally at 10. The system 10 may be utilized in conjunction with a boom and collection tank which are used to collect a mixed oil-water from a spill location. Optionally, the system may be located at remote site and operable to treat the collected waste water as stored within a holding tank. The system comprises a flotation tank 12 configured to receive the oil-water and a selectable adsorption tank 40 selectably downstream of the flotation tank 12. The flotation tank 12 is operable to pass a stream bubbles, such as by way of non-limiting example, micro or nano bubbles through the waste water in the flotation tank to perform a first oil removal from the water and allow the removal of separated water therefrom and a separated oil therefrom.

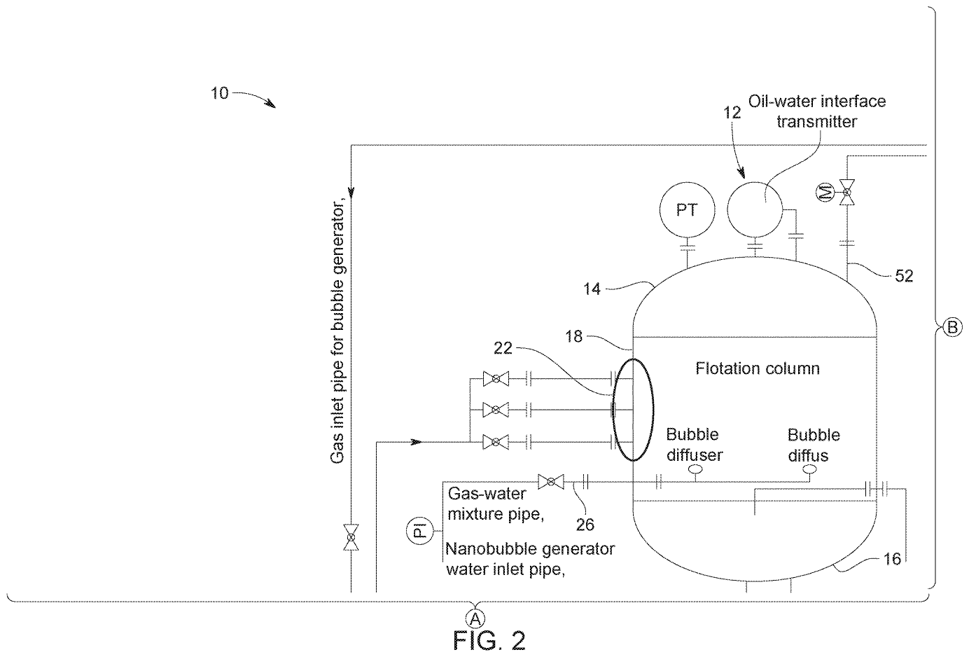

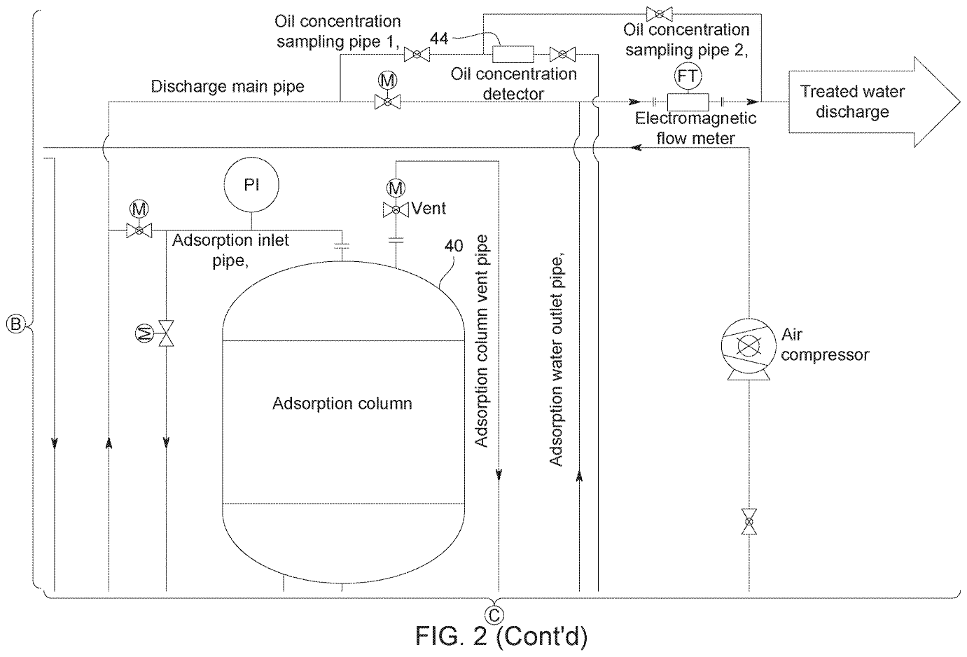

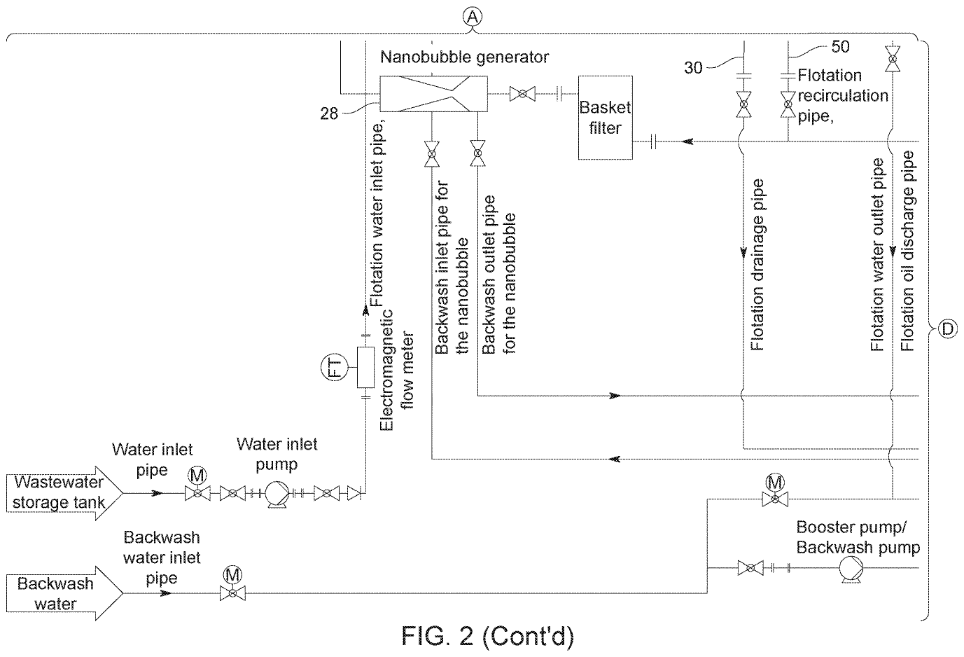

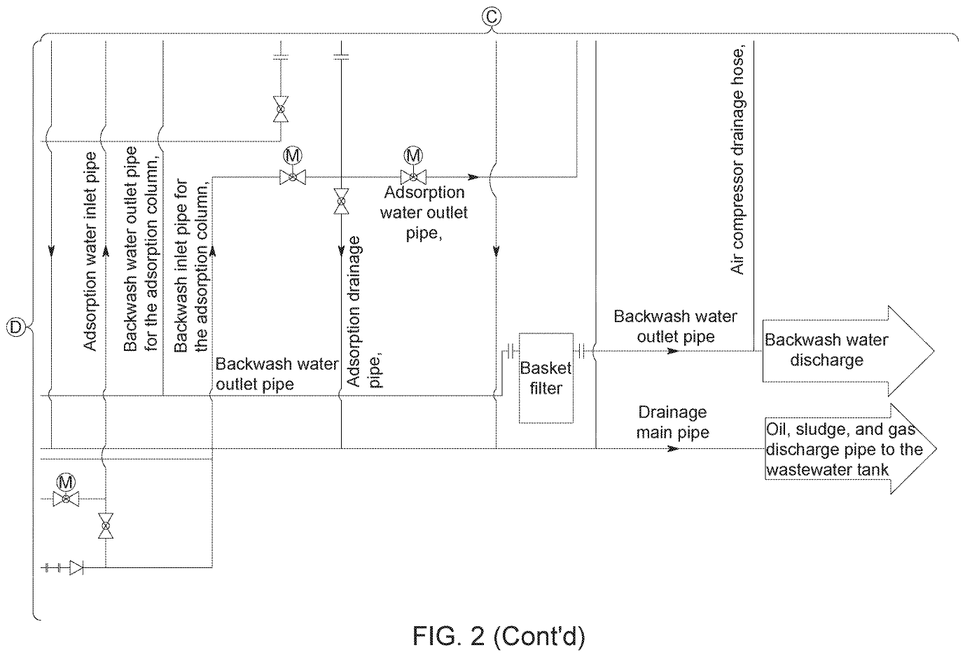

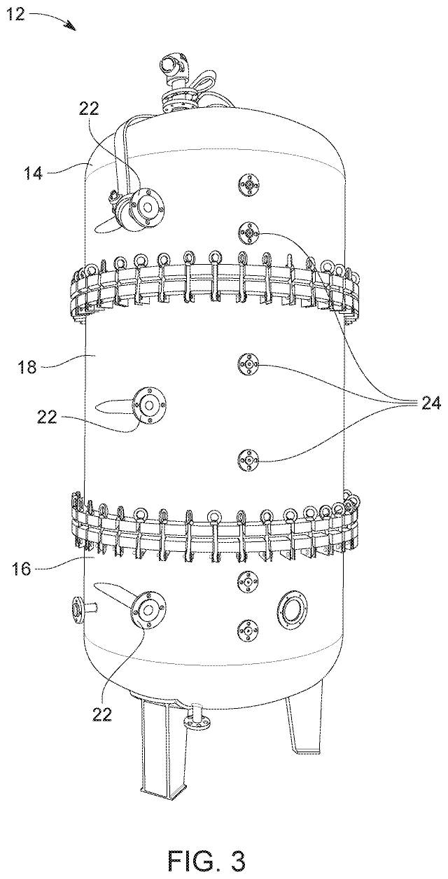

As illustrated in FIGS. 2 and 3, the flotation tank 12 includes a top cap 14, a bottom cap 16 and at least one middle section 18. The middle sections 18 may include flanges and seals operable to be sealably coupled to the top and bottom caps to form a cylindrical tank 12. One or more middle sections 18 may be utilized depending on the capacity requirements of the system. In particular, for environments where a greater throughput capacity of wastewater are required, more middle sections 18 may be used to increase the height of the flotation tank. Each middle section 18 may include a plurality of testing outputs 20 for sampling the liquid at that height in the column as shown in FIG. 3. Furthermore each middle section 18 may include a plurality of wastewater inputs 22 for introducing wastewater at one of a plurality of heights. It will also be appreciated that the top and bottom caps may include a cylindrical section as illustrated in FIG. 2 and that furthermore each of the top and bottom caps may also include wastewater inputs and/or testing outputs 20. Such designs may therefore allow the use of flotation tanks without middle section for minimum capacity applications. As illustrated in FIG. 3, the inputs may be vertically aligned with each other although other orientations may be utilized as well.

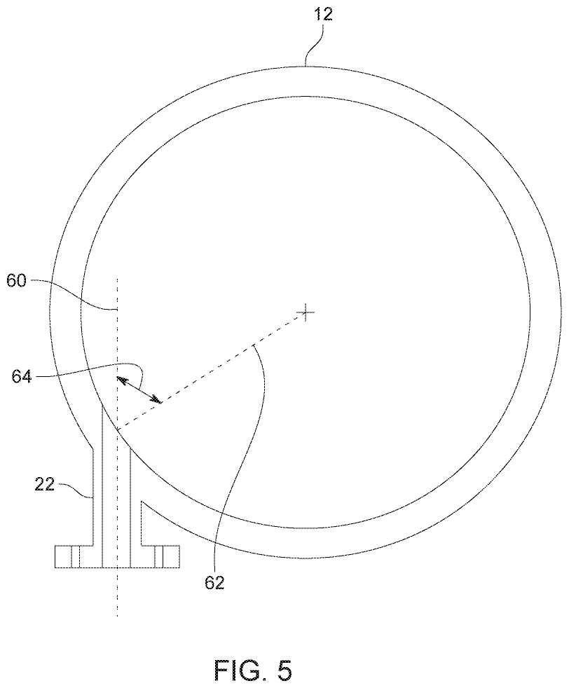

As illustrated in FIG. 5, each of the wastewater inputs 22 may include an outlet direction, generally indicated at 60 with is angularly oriented relative to a radius 62 of the flotation tank at an angle generally indicated at 64 so as to induce a swirl motion to the wastewater in the flotation tank which minimizes the disturbance on the separated water at the tank bottom and promotes efficient oil/water separation. Although a single input is illustrated in FIG. 5, it will be appreciated that more than one input at a cross sectional plane may also be utilized and distributed around the tank.

The bottom cap 16 includes a separated water removal port 30 therethrough to remove the separated water from the flotation tank and a bubble injection input 26 extending thereinto. A bubble generator 28 coupled to the bubble injection input 26 is operable to create nano and micro gas bubbles to float oil in the flotation column. By way of non-limiting example the bubble generator may include a compressor operable to compress air to the outlet nozzles in the flotation tank. It will be appreciated that the micro or nano bubbles may be formed of air although other gasses, including without limitation oxygen or nitrogen may also be utilized. The micro or nano bubbles are selected to have size of less than 1 micrometer and optionally less than 200 nanometers. The top cap 14 may include a gas vent to vent gas produced in the flotation tank to atmosphere although gas collection ports may also be utilized to recover and redirect the produced gas back to the bubble generator for recycling. The top cap also includes a separated oil removal means including, without limitation, an exit port 54, an overflow collection or any other means as are known for collecting and removing the separate oil from the flotation tank 12. Optionally, the system may include a recirculation port 50 at a bottom portion of the flotation tank 12 for recirculation of the water and bubble mixture through the bubble generator and out of the bubble diffusers in the bottom portion of the flotation tank. In operation, the micro and nano bubbles will separate the oil from the water and float to the top such that the separated oil can be removed therefrom for collection and the separated water can be removed from the bottom of the flotation tank 12

The system 10 also includes an adsorption tank 40. The adsorption tank is located after the flotation tank and is configured to selectably receive the separated water output from the flotation tank. The adsorption tank removes residual oil not fully separated in the flotation tank. The adsorption tank 40 includes an input and an output and contains a quantity, including in a layer or any other arrangement, of oil-adsorbing materials, such as, by way of non-limiting example, fiber balls, activated carbon or oil absorbing sponges. The input is fluidically coupled to the flotation tank 12 and the output is coupled to a discharge to environment or other location. It will be appreciated that other oil-adsorption materials can also be used operable to adsorb trace amounts of oil in separated water. The system may include a sensor 44 between the flotation tank 12 and the adsorption tank to measure the concentration of the remaining oil in the separated water. By way of non-limiting example, the sensor 44 may comprise a UV fluorescence oil content detector. The sensor may be installed near the outlet to monitor the oil concentration in the treated water, ensuring the treated water meets predefined discharge standards. If the concentration is above a predetermined level, the separated water will be directed to the adsorption tank. If the concentration is below the predetermined level, the separated water may be discharged to the environment directly. Optionally, a backwash system may be included in the adsorption tank as are known to periodically clean the filler materials, maintaining effective adsorption capacity. The filter layers may be selected to be easily replaceable to meet the treatment needs for various types and concentrations of oil-contaminated water. The adsorption tank 40 may be provided with an access port or other means for adding and removing the filter media therein.

A controller 100 may also be provided to control the operation of the system, including the pumps and valves utilized to control the flow rates, water levels and directions of the flow of water and/or oil through the system. In particular, each of the wastewater inputs 22 may include an associated valve operable to control the flow rate of waste water through that valve. In such a manner, the controller can control the waste water input at each height in the flotation tank as well as the overall flowrate through the tank. Valves may also be provided at the separated water output and separated oil output to control the fluid height in the flotation tank as well as the boundary height between the separated oil floating on the top of the flotation tank and the combined oil-water below. A diverter valve is also included in the separated water output to direct the separated water to either a discharge or to the adsorption tank for further separation as determined by the controller.

The system may also include sensors operable to measure, concentration, pressure and fluid levels in the various components. In particular an oil-water interface sensor may be provided in the flotation tank to measure the height of the boundary between the oil-water wastewater and the oil floating on top. Furthermore, an oil concentration sensor may be configured to measure the concentration of oil in the separated water. In particular, The top of the gas flotation tank includes a pressure sensor, an oil-water interface sensor, and an oil discharge port, wherein the pressure sensor provides real-time monitoring of tank pressure, the oil-water interface sensor detects the thickness of the oil layer at the top of the liquid, and when a certain thickness of separated oil layer is detected, the oil discharge port opens for oil removal, with the oil discharge port connected to an oil discharge pipe at the rear of the system for oil collection. Furthermore, the top of the adsorption tank may include a pressure gauge for real-time monitoring of internal tank pressure.

The controller may comprise any known processor, and may include one or more processing circuits operable to perform the presently described functions including local or remote computers, programmable logic controller (PLC) and the like. The controller may further include and database and optional memory. The memory may stores machine instructions that, when executed by the processor, cause the processor to perform one or more of the operations and methods described herein. The memory of any known type including a cache memory unit for temporary local storage of instructions, data, or computer addresses. The design and operation system may further include the database either internally or externally and may be of any conventional type operable to store the information and fields required by the processor information.

More generally, in this specification, the term “controller” is intended to broadly encompass any type of device or combination of devices capable of performing the functions described herein, including (without limitation) other types of microprocessors, microcontrollers, other integrated circuits, other types of circuits or combinations of circuits, logic gates or gate arrays, or programmable devices of any sort, for example, either alone or in combination with other such devices located at the same location or remotely from each other. Additional types of controllers(s) will be apparent to those ordinarily skilled in the art upon review of this specification, and substitution of any such other types of processor(s) is considered not to depart from the scope of the present invention as defined herein. Optionally, the controller may be located at a remote location operable to control the operation of the system and communicate through a network such as, by way of non-limiting example, Wi-Fi, internet, cellular or satellite networks.

Computer code comprising instructions for the processor(s) to carry out the various embodiments, aspects, features, etc. of the present disclosure may reside in the memory, within the processor or be obtained from outside the system according to know means. The controller may also include an input/output and/or network interface to allow an operator to monitor, control and adjust the operation of the system.

In operation, the system operation is divided into two main stages: nano and microbubble gas flotation separation and adsorption separation. During the flotation separation state, oil-contaminated water is first transported to the centripetal swirl gas flotation tank by an inlet pump, where the nano-bubble generator produces numerous nano and micro gas bubbles that collide with oil particles forming large and light gas-oil droplets, causing them to float to the surface and separate from the water, with separated water being discharged from the bottom of the flotation tank and floated oil being discharged from the top of the flotation tank. The oil-water interface sensor continuously monitors the height of the oil-water interface in the flotation tank. When the oil layer reaches a certain thickness, it is discharged to prevent excessive oil buildup in the tank, which could affect separation efficiency.

If the oil concentration in the treated water after gas flotation separation stage is higher than the set value (e.g., 15 ppm or other number), the treated water will flow from the bottom of the flotation tank into the top of the adsorption tank which contains oil adsorption materials for further removal of residual oil contents.

The oil content detector continuously monitors the oil concentration at the outlet of the gas flotation and adsorption tanks to ensure that the treated water meets a predetermined threshold. When the oil concentration falls below a preset threshold, the system permits water discharge. If the oil content exceeds the limit, the system automatically initiates recirculation of the water back into the flotation or adsorption tank, or further processing until the discharge standards are met.

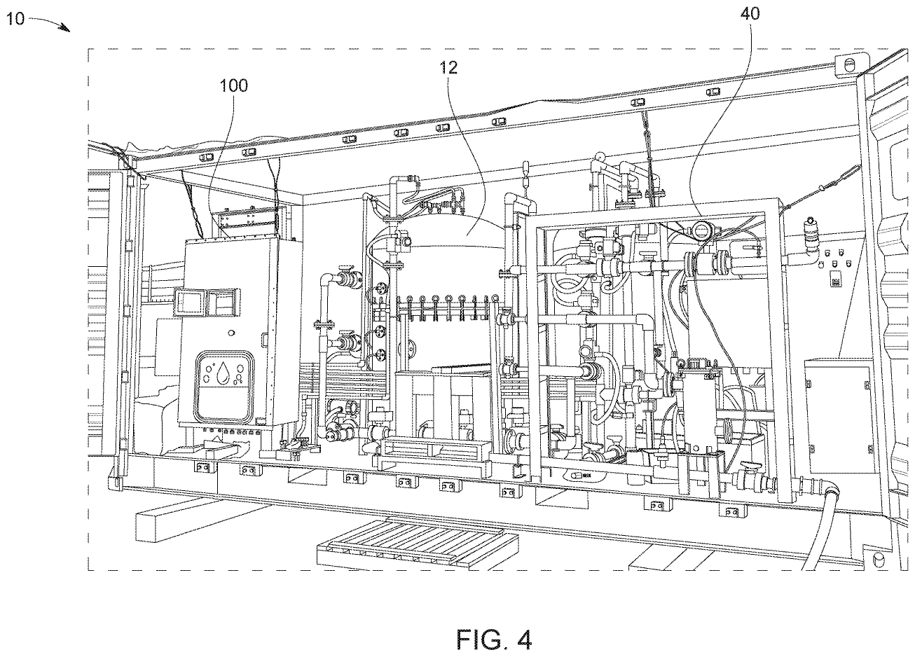

As illustrated in FIG. 4, the system may be contained within a portable container, such as, by way of non-limiting example, a standard shipping container so as to be easily transportable to a desired location for rapid and flexible response to a spill.

The present system provides an integrated and environmentally friendly decanting process for oil/water separation in responding to oil spill incidents. This process employs nano and micro bubble gas flotation and adsorption technologies to efficiently separate oil from emulsified oily wastewater.

The system allows automated control functions, allowing real-time monitoring of the oil content in the treated water to ensure it meets environmental standards. This process allows for rapid response to offshore or onshore oil spill incidents, as well as industrial oil-contaminated wastewater treatment.

While specific embodiments have been described and illustrated, such embodiments should be considered illustrative only and not as limiting the disclosure as construed in accordance with the accompanying claims.

What is claimed is:

1. A system for separating oil and water comprising:
a flotation tank having an contaminated water inlet, an oil outlet, and a water outlet;
a bubble generator operably connected to the bubble inlet and operable to supply a quantity of bubbles into the interior of the flotation tank,
wherein the oil outlet removes a quantity of oil collected by the bubbles from the interior of the flotation tank and the water outlet removes a quantity of the water having the oil removed therefrom from the interior of the flotation tank;
an adsorption tank containing a quantity of an oil-absorbing material selectably connected to water outlet; and
a sensor operable cause water exiting the flotation tank through the water outlet to be directed to the adsorption tank when the concentration of oil in the water exiting the flotation tank exceeds a predetermined value.

2. The system of claim 1 wherein the contaminated water inlet is oriented at an angle relative to radial along the horizontal plane so as to induce a centripetal swirl motion in the flotation tank.

3. The system of claim 1 wherein the contaminated water inlet comprises a plurality of inlets.

4. The system of claim 3 wherein the plurality of inlets are arranged in a vertically spaced apart relation to each other.

5. The system of claim 4 wherein the plurality of inlets are arranged radially around the flotation tank.

6. The system of claim 4 wherein the plurality of inlets are selectable to adjust height in the flotation tank at which the contaminated water is introduced.

7. The system of claim 1 further comprising an inlet pump to introduce the contaminated water into the flotation tank.

8. The system of claim 7 further comprising a holding tank operable to hold a quantity of the contaminated water wherein the inlet pump draws contaminated water from a bottom portion of the holding tank.

9. The system of claim 1 further comprising a plurality of middle columns.

10. The system of claim 9 wherein the middle columns are sealably connected to each other and the top and bottom caps with fasteners.

11. The system of claim 1 further comprising a processor configured to receive data from the sensor and direct the water exiting the flotation tank to the adsorption tank if the oil concentration is above a predetermined level or to a discharge if the oil concentration is below the predetermined level.

12. The system of claim 1 wherein the flotation tank includes bubble distribution ports therein.

13. The system of claim 1 wherein the bubble generator is configured to recirculate a bubble-air mixture through the tank.

14. The system of claim 1 further comprising a backwash system operable to periodically clean the filler materials in the adsorption tank.

15. The system of claim 1 wherein the flotation tank includes at least one sampling port for drawing off a quantity of the contents of the flotation tank.

16. The system of claim 15 wherein the at least one sampling port comprises a plurality of sampling ports.

17. The system of claim 16 wherein the plurality of sampling ports are arranged at varying heights along the flotation tank.

18. An apparatus for separating oil and water comprising:
a bottom cap having a separated water output therethrough and a bubble injection port extending thereinto;
a top cap having a gas removal port therethrough and a separated oil port therethrough, and
at least one cylindrical middle column sealably locatable between the top and bottom caps, the middle column including at least one mixture inlet port operable to introduce a quantity of an oil-water mixture into the tank.

19. The apparatus of claim 18 further comprising a plurality of middle columns.

20. A method for separating oil and water comprising:
introducing a quantity of an oil contaminated water to a flotation tank;
introducing a quantity of bubbles to the flotation tank at a bottom thereof;
drawing a separated oil portion at a top of the flotation tank;
drawing a separated water portion at a bottom of the flotation tank;
measuring the oil concentration in the separated water portion; and
passing the separated water portion through an adsorption tank containing a quantity of an oil-absorbing material if the oil concentration in the separated water portion is above a predetermined value.
